(19) United States
(12) Patent Application Publication
(10) Pub. No.: US 2013/0187107 A1
(43) Pub. Date: Jul. 25, 2013

(54) Pneumatic Jack

(71) Applicant: Albert V. Coccaro, Mt. Kisco, NY (US)

(72) Inventor: Albert V. Coccaro, Mt. Kisco, NY (US)

(21) Appl. No.: 13/355,663

(22) Filed: Jan. 23, 2012

(51) Int. Cl. B66F 3/35

(52) U.S. Cl. 254/93 R

(57) ABSTRACT

An apparatus comprises a base, a top member, and a bladder. The top member defines a proximal end and a distal end. The proximal end of the top member is pivotally coupled to the base. The bladder, in turn, is disposed between the base and the top member. Arranged in this manner, the apparatus is operative to raise the distal end of the top member away from the base as the bladder is inflated.

### FIELD OF THE INVENTION

The present invention relates generally to apparatus for applying a lifting force to a stationary object, and, more particularly, to pneumatic jacks.

### BACKGROUND OF THE INVENTION

Pneumatic jacks are frequently found in automobile repair facilities. Many such jacks utilize air springs (sometimes called “air lift bags,” “air struts,” or “air bellows”) to create a lifting force. An air spring may comprise a reinforced bladder. Inflation of the bladder by compressed air causes the air spring to expand. A jack pad at the top of the pneumatic jack contacts the vehicle and allows the air spring to raise the vehicle. Pneumatic jacks with air springs may have lifting capacities of three tons or more.

While air-spring-based pneumatic jacks have several advantages, many suffer from the inability to be lowered sufficiently to be used to lift vehicles that sit relatively low to the ground (i.e., low profile vehicles). Because of the space occupied by the air spring when collapsed, an air-spring-based pneumatic jack may only have a minimum lifting height (i.e., collapsed height) of five inches or more. An automobile repair facility may therefore be required to use a conventional floor jack when lifting a low profile vehicle, and, in doing so, forego the ease of use, speed, safety, and convenience of an air-spring-based pneumatic jack. Conventional hydraulic floor jacks may be readily acquired with minimum lifting heights of, for example, only three inches.

For the foregoing reasons, there is a need for air-spring-based pneumatic jack designs having minimum lifting heights compatible with low profile vehicles and other low-standing objects. At the same time, these pneumatic jack designs should provide ample lifting capacities and maximum lifting heights, while also being safe, fast, and easy to use.

### SUMMARY OF THE INVENTION

Embodiments of the present invention address the above-identified needs by providing pneumatic jack designs operative to lift low profile vehicles and other low-standing objects.

In accordance with an aspect of the invention, an apparatus comprises a base, a top member, and a bladder. The top member defines a proximal end and a distal end. The proximal end of the top member is pivotally coupled to the base. The bladder, in turn, is disposed between the base and the top member. Arranged in this manner, the apparatus is operative to raise the distal end of the top member away from the base as the bladder is inflated.

In accordance with another aspect of the invention, a method for lifting an object comprises receiving a base and pivotally coupling a proximal end of a top member to the base. A bladder is placed between the base and the top member. Once so configured, a distal end of the top member is raised away from the base by inflating the bladder.

One of the above-identified embodiments comprises a base, a top member, a mounting block, a stabilizing member, an air spring, and an air control valve. A proximal end of the top member is pivotally coupled to the base, while a distal end of the top plate is pivotally coupled to the mounting block. At the same time, the stabilizing member is also pivotally coupled to the base and to the mounting block, although at different locations from the top member. The air spring sits between the base and the top member. Inflating the air spring with the air control valve causes the distal end of the top member and the mounting block to rise away from the base. While the mounting block is rising, the top member and the stabilizing member cooperate to maintain the mounting block at a substantially constant orientation relative to the base.

### BRIEF DESCRIPTION OF THE DRAWINGS

These and other features, aspects, and advantages of the present invention will become better understood with regard to the following description, appended claims, and accompanying drawings where:

FIG. 1 shows a left perspective view of a pneumatic jack in accordance with a first illustrative embodiment of the invention;

FIG. 2 shows a partially cutaway left perspective view of the FIG. 1 pneumatic jack;

FIG. 3 shows an exploded perspective view of the FIG. 1 pneumatic jack;

FIG. 4 shows an exploded perspective view of the air spring in the FIG. 1 pneumatic jack;

FIG. 5 shows a sectional view of the handle and receiving block in the FIG. 1 pneumatic jack;

FIG. 6 shows a right elevational view of the FIG. 1 pneumatic jack in its lowered state;

FIG. 7 shows a partially cutaway right elevational view of the FIG. 1 pneumatic jack transitioning from its lowered state to its raised state;

FIG. 8 shows a left perspective view of a pneumatic jack in accordance with a second illustrative embodiment of the invention; and

FIG. 9 shows a partially cutaway left elevational view of the FIG. 8 pneumatic jack.

### DETAILED DESCRIPTION OF THE INVENTION

The present invention will be described with reference to illustrative embodiments. For this reason, numerous modifications can be made to these embodiments and the results will still come within the scope of the invention. No limitations with respect to the specific embodiments described herein are intended or should be inferred.

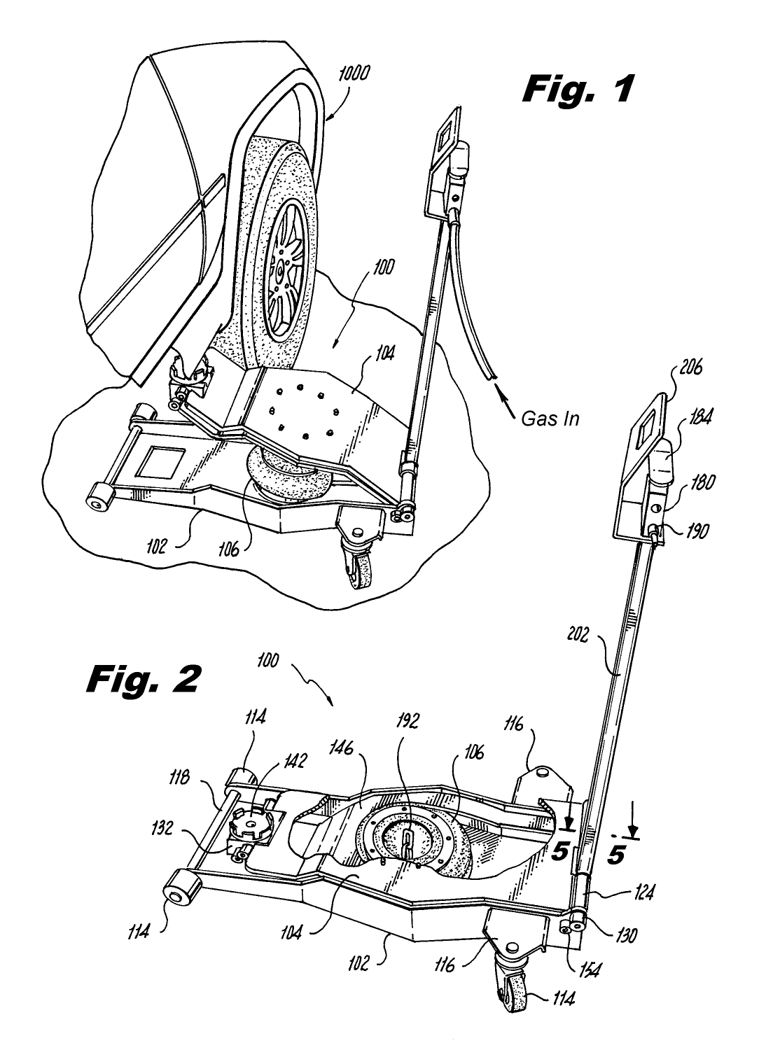

FIG. 1 shows a left perspective view of a pneumatic jack 100 in accordance with a first illustrative embodiment of the invention. In the figure, the pneumatic jack 100 is being used to raise an automobile 1000. Nevertheless, embodiments of the invention may more generally be used to raise vehicles as well as various other types of objects. At its most basic, the illustrative pneumatic jack 100 comprises a base 102, a top member 104, and an air spring 106. The top member 104 defines a proximal end and a distal end. The proximal end of the top member 104 is pivotally coupled to the base 102. The air spring 106, in turn, is disposed between the base 102 and the top member 104. Arranged in this manner, the pneumatic jack 100 is operative to raise the distal end of the top member 104 away from the base 102 as the air spring 106 is inflated. Once so raised, deflation of the air spring 106 allows the distal end of the top member 104 to drop back towards the base 102.

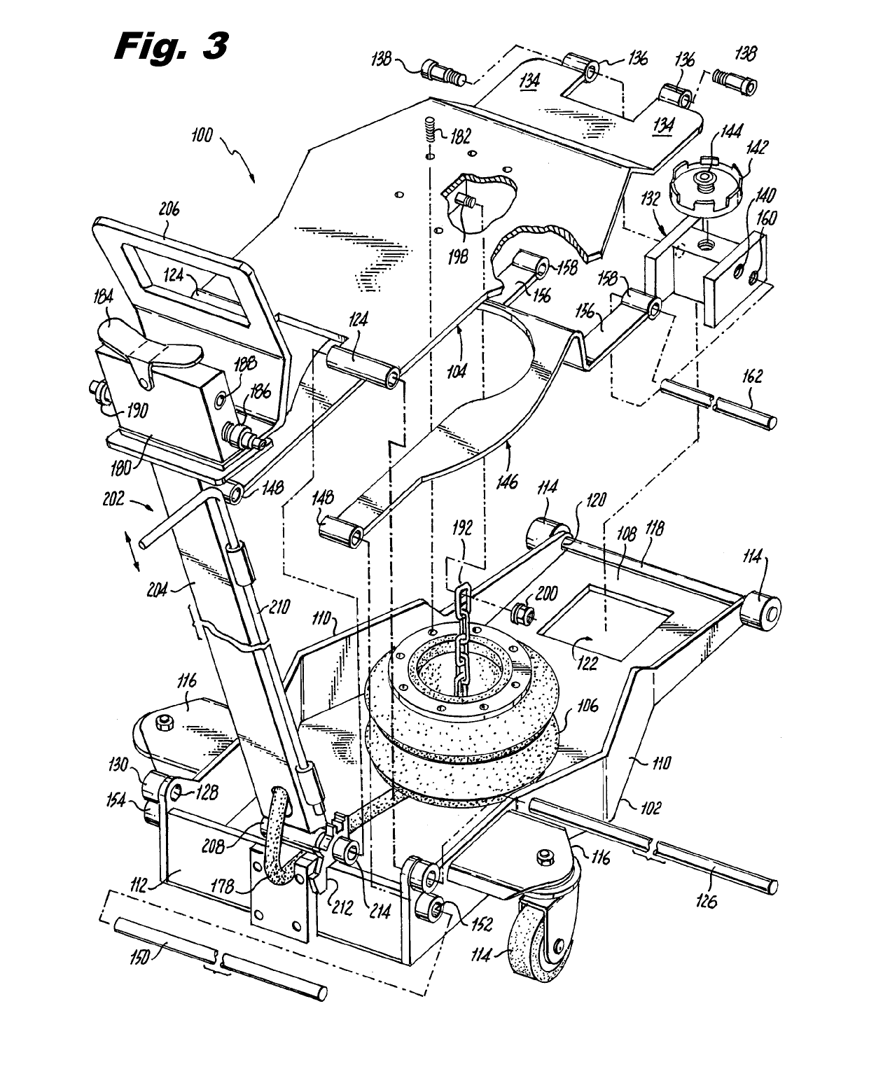

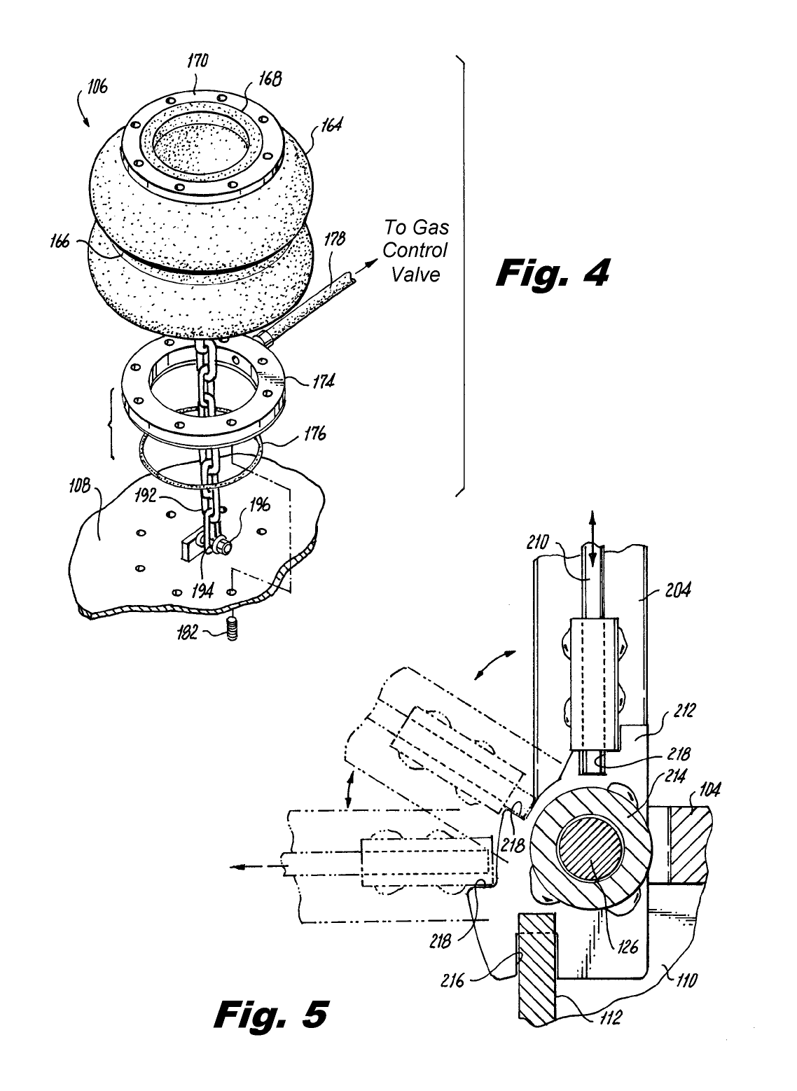

FIGS. 2-4 go on to show additional details of the illustrative pneumatic jack 100. More particularly, FIG. 2 shows a partially cutaway left perspective view of the pneumatic jack 100; FIG. 3 shows an exploded perspective view of the pneumatic jack 100; and FIG. 4 shows an exploded perspective view of the air spring 106 in the pneumatic jack 100.

In the illustrative pneumatic jack 100, the base 102 comprises a floor plate 108, two opposing sidewalls 110, and a back wall 112. Four wheels 114 are coupled to the base 102. Two castering wheels 114 are affixed under two wheel support plates 116 that project outward from the remainder of the base 102 near the base's proximal end. At the distal end of the base 102, two additional wheels 114 are affixed to a frontal rod 118 that passes through a frontal set of apertures 120 in the two opposing sidewalls 110 of the base 102. The floor plate 108 also defines a window 122, which, as will be described later, facilitates the pneumatic jack 100 in achieving a lower minimum lifting height.

The top member 104 comprises an elongate plate with a downward step about two-thirds along its length. As indicated earlier, the proximal end of the top member 104 is pivotally coupled to the base 102. In the present illustrative embodiment, this pivotal coupling is achieved by having the top member 104 define an upper pair of proximal hollow cylinders 124. Each of the upper pair of proximal hollow cylinders 124 is arranged coaxially with the other and surrounds an upper support rod 126. The upper support rod 126 itself is supported by an upper pair of apertures 128 in the two opposing sidewalls 110 of the base 102 in combination with an upper pair of external cylindrical supports 130. The upper pair of external cylindrical supports 130 are mounted external to the two opposing sidewalls 110, as may be seen in FIGS. 2 and 3.

A mounting block 132 is pivotally coupled to the distal end of the top member 104. Here, the top member 104 defines a pair of top member extensions 134 that are spaced apart from one another. The pair of top member extensions 134 terminate in an upper pair of distal hollow cylinders 136, again arranged coaxially to one another. Two partially threaded bolts 138 pass through the upper pair of distal hollow cylinders 136 and engage threaded holes 140 tapped into opposing sides of the mounting block 132. When screwed into the mounting block 132, the smooth (non-threaded) regions of the two partially threaded bolts 138 fall within the upper pair of distal hollow cylinders 136 and allow the two partially threaded bolts 138, and ultimately the mounting block 132, to pivot freely therein. The mounting block 132 is thereby at least partially disposed between the pair of top member extensions 134 in this manner.

The mounting block 132 is adapted to support a jack pad 142. In this particular embodiment, the jack pad 142 is attached to the mounting block 132 via a single attachment screw 144, although other means of attachment are contemplated and would also fall within the scope of the invention. Use of the single attachment screw 144 allows the jack pad 142 to be rotated relative to the mounting block 132. Moreover, the ability to readily swap jack pads allows different jack pads to be utilized for different applications. The particular exemplary jack pad 142 shown in the figures is well suited for engaging a lift point on a vehicle, but this is merely one example of many possible designs. The jack pad 142 can be easily customized for particular applications (e.g., for engaging a pinch weld on the object being lifted).

In addition to the top member 104, the pneumatic jack 100 further comprises a frame-like stabilizing member 146 that lies below the top member 104. The stabilizing member 146 is pivotally coupled to the base 102 and to the mounting block 132, and has a length along a longitudinal axis of the pneumatic jack 100 similar to that of the top member 104. Moreover, the stabilizing member 146 also has a downward step about two-thirds down its length. Nevertheless, while similar to the top member 104 in these ways, the stabilizing member 146 is distinct from the top member 104, and pivotally couples to the base 102 and to the mounting block 132 at locations different from the top member 104. To pivotally couple to the base 102, the stabilizing member 146 defines a lower pair of proximal hollow cylinders 148, each of which is coaxial with the other and surrounds a lower support rod 150. The lower support rod 150 is positioned slightly lower and slightly forward (i.e., in a direction towards the left in FIG. 2) of the upper support rod 126. In a manner similar to the upper support rod 126, the lower support rod 150 is supported by a lower pair of apertures 152 in the two opposing sidewalls 110 of the base 102, as well as by a lower pair of external cylindrical supports 154.

As can be further seen in FIGS. 2 and 3, the stabilizing member 146 defines an opening through which the air spring 106 passes. At the distal end of the stabilizing member 146, the stabilizing member 146 forms a pair of stabilizing member extensions 156 that are spaced apart from each other. Each of the pair of stabilizing member extensions 156, in turn, defines a respective one of a lower pair of distal hollow cylinders 158. The lower pair of distal hollow cylinders 158 are aligned with a round passage 160 in the mounting block 132. Moreover, the lower pair of distal hollow cylinders 158 and the round passage 160 in the mounting block 132 are positioned slightly lower and slightly forward of where the top member 104 couples to the mounting block 132, mimicking the spatial relationship between the upper and lower support rods 126, 150 at the proximal end of the base 102. A distal rod 162 passes through the lower pair of distal hollow cylinders 158 and the round passage 160 in the mounting block 132 to implement the pivotal coupling between the mounting block 132 and the stabilizing member 146.

The air spring 106 shown in the figures is of a double convoluted type. A bladder 164 defines two interconnected chambers resembling a pair of stacked tires. The bladder 164 may, for example, comprise multiple plies of cord-reinforced rubber. A seam between the two chambers is surrounded by a ring 166, sometimes called a “girdle hoop.” In order to form an airtight seal with the top member 104, an uppermost lip 168 of the bladder 164 is pressed against the top member 104 by an upper flange 170. At the opposite end of the bladder 164, a lowermost lip (not visible) is captured between a first lower flange 172 and a second lower flange 174. An elastic O-ring 176 (e.g., rubber O-ring) is placed between the second lower flange 174 and the floor plate 108 of the base 102 to form an airtight seal therebetween. The second lower flange 174 also receives an air hose 178 from a gas control valve 180 that facilitates the inflation and deflation of the bladder 164. Multiple threaded bolts 182 engage threads in the various flanges 170, 172, 174 and allow the flanges 170, 172, 174 to be fixedly attached to the top member 104 and to the base 102, as appropriate.

While the particular air spring 106 shown in the figures is of the double convoluted type, this design choice is merely illustrative. More generally, any form of bladder or bellows capable of being inflated may be utilized in place of the illustrative air spring 106 and the results would still come within the scope of the invention. For example, instead of utilizing a double convoluted air spring, a single convoluted air spring or a triple convoluted air spring could be utilized instead. Moreover, in one or more alternative embodiments of the invention, a rolling lobe air spring or sleeve bag air spring could also be implemented.

Inflation and deflation of the air spring 106 are manually controlled via the gas control valve 180. The gas control valve 180 may be of the type used for pneumatic lifts and hoists. More particularly, the gas control valve 180 is preferably of the “two step” type, allowing a compressed gas to be directed into and out of the air spring 106, as well as allowing the air spring 106 to be isolated so that it remains in a given state (e.g., raised or lowered). In the present embodiment, the gas control valve 180 includes a rocker 184 that allows the user to select between inflation and deflation by pressing on one side of the rocker 184 or the other. In use, a compressed gas such as compressed air is introduced into the gas control valve 180 via an input port 186. A suitable pressure for the compressed gas may be, for example, about 105 pounds per square inch (psi). Gas released during deflation is expelled through an exhaust port 188. To avoid over-pressurizing the air spring 106, a pressure relief safety valve 190 is fitted to the gas control valve 180.

Moreover, in accordance with aspects of the invention, the illustrative pneumatic jack 100 further comprises a chain 192. The chain 192 may be seen, for example, in FIGS. 2-4. The chain 192 resides within the air spring 106. One end of the chain 192 is attached to the floor plate 108 of the base 102 via a lower threaded mounting pin 194 and a lower nut 196, and the other end of the chain 192 is attached to the top member 104 via an upper threaded mounting pin 198 and an upper nut 200. In this manner, the chain 192 spans between the base 102 and the top member 104 and limits an extent to which the pneumatic jack 100 can raise the distal end of the top member 104 away from the base 102. Once the chain 192 is fully extended, the distal end of the top member 104 cannot rise any further. Instead, any additional inflation of the air spring 106 only acts to increase the pressure in the air spring 106. Excessive pressure is relieved by the pressure relief safety valve 190, as necessary, to maintain safety. While a chain is utilized in the present embodiment, alternative embodiments can utilize any form of linking member including, but not limited, to a chain, a cord, a cable, a strap, a belt, or a combination thereof.

In the present embodiment, transport and positioning of the pneumatic jack 100 is further facilitated by a handle 202. The handle 202 comprises an elongate handle portion 204 that terminates at its top in the gas control valve 180 and a grip 206. At the bottom of the elongate handle portion 204, the handle 202 defines a bottom hollow cylinder 208 that surrounds the upper support rod 126 (i.e., the same support rod supporting the top member 104). The handle 202 is thereby pivotally coupled to the base 102 in this manner. A handle adjustment pin 210 runs down the elongate handle portion 204 and impinges on a receiving block 212. The receiving block 212, in turn, defines a receiving block hollow cylinder 214 that also surrounds the upper support rod 126 (best seen in FIG. 3). However, unlike the handle 202, the receiving block 212 is not allowed to rotate relative to the base 102. Instead, the receiving block 212 further defines a receiving block notch 216 that engages the back wall 112 of the base 102. Rotation of the receiving block 212 relative to the base 102 is thereby substantially eliminated.

FIG. 5 shows a sectional view that highlights aspects of the handle 202 and the receiving block 212. The receiving block 212 and the handle adjustment pin 210 cooperate to provide a locking mechanism for fixing an angle at which the handle 202 couples to the base 102. In the present embodiment, the receiving block 212 defines three handle adjustment notches 218 into which the handle adjustment pin 210 may drop when the handle 202 achieves one of three handle positions: a “raised” position wherein the handle 202 stands substantially upright and about normal to the base 102; a “middle” position wherein the handle 202 is at an oblique angle relative to the base 102; and a “lowered” position wherein the handle 202 lies substantially flat and about parallel with the base 102. With the handle 202 in its raised or middle positions, lowering the handle 202 is inhibited by the handle adjustment pin 210 striking a vertical sidewall of one of the handle adjustment notches 218. A user may manually overcome this locking mechanism by simply lifting up on the handle adjustment pin 210 when lowering the handle angle.

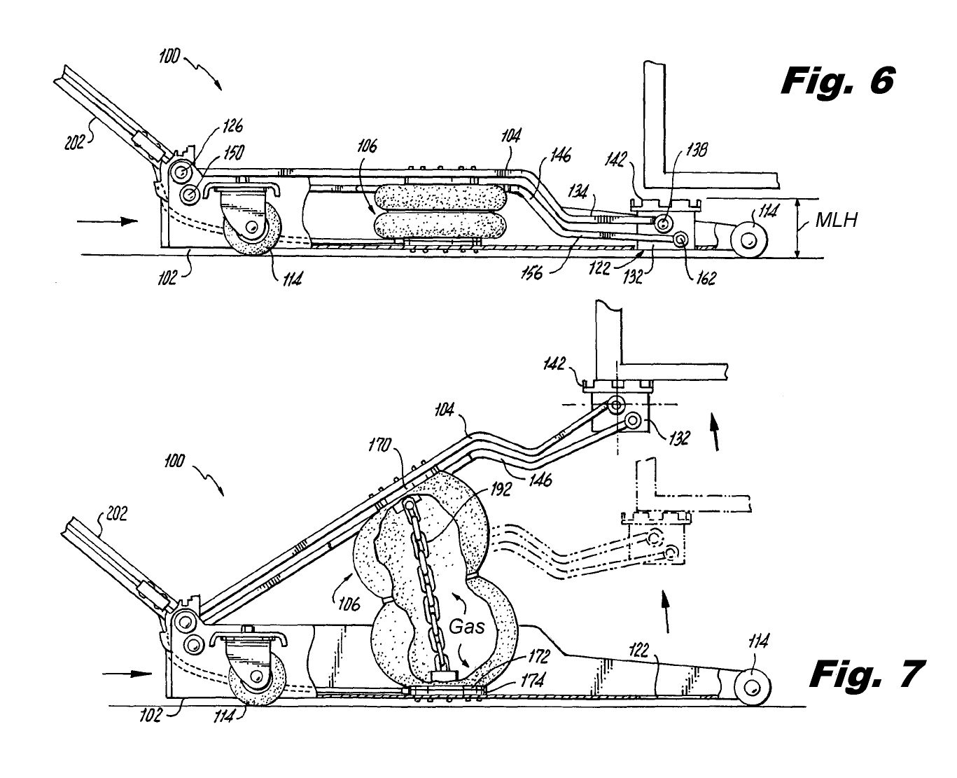

FIGS. 6 and 7 act to reveal additional details of how the pneumatic jack 100 functions when lifting an object. FIG. 6 shows a right elevational view of the pneumatic jack 100 in its lowered state while the pneumatic jack 100 is in place to lift an object. FIG. 7 shows a partially cutaway right elevational view of the pneumatic jack 100 transitioning from its lowered state to its raised state.

In its lowered state, the window 122 in the floor plate 108 of the base 102 allows the mounting block 132 to be dropped even lower to the ground so as to achieve the most favorable minimum lifting height (labeled as “MLH” on FIG. 6). Inflation of the air spring 106, in turn, causes the distal end of the top member 104 to describe an arc when rising away from the base 102. Because such an arc-like path might be unfavorable if it were to induce a tilting (or torqueing) motion in the mounting block 132, any tilting of the mounting block 132 while being raised or lowered is substantially eliminated by the top member 104 and the stabilizing member 146. More particularly, the geometries of the top member 104 and the stabilizing member 146, as well as their various pivotal connections to the base 102 and mounting block 132, cooperate to pivot the mounting block 132 so that it remains at a substantially constant orientation relative to the base 102 while the pneumatic jack 100 raises and lowers the distal end of the top member 104. The mounting block 132 thereby remains substantially level while in use. The raising and lowering of the distal end of the top member 104 is also accompanied by a small translation of the mounting block 132 towards and away from, respectively, the proximal end of the base 102. Nevertheless, this lateral translation is compensated for by simply allowing the entire pneumatic jack 100 to roll forward and backward slightly on its wheels 114 so that the mounting block 132 remains stationary under the object being lifted.

As indicated in the Background, a conventional pneumatic jack, namely one comprising a jack pad that sits directly on top of an air spring, may have a minimum lifting height of five inches or more in large part due to the height occupied by the air spring when it is deflated (i.e., collapsed). At the same time, the stroke of such a conventional pneumatic jack (i.e., the difference in height of the jack pad when the pneumatic jack is fully raised and fully lowered) is limited by the extent by which the air spring increases in height when inflated. A conventional pneumatic jack with a double convoluted air spring, for example, may only have a stroke of about eight inches. A conventional pneumatic jack with a triple convoluted air spring may only have a stroke of about 12 inches.

Aspects of the invention address these shortcomings. In the pneumatic jack 100, for example, the shapes of the top member 104 and the mounting block 132 allow the jack pad 142 to be positioned lower than the height of the top of the air spring 106 (see FIG. 6). Concurrently, the placement of the air spring 106 under the top member 104 relative to the point where the top member 104 pivotally couples to the base 102 (the “hinge point of the top member”) allows the pneumatic jack 100 to achieve a stroke greater than the extent by which the air spring 104 increases in height when inflated (see FIG. 7). In fact, the maximum lifting height of a pneumatic jack in accordance with aspects of the invention may be modified by adjusting the position of the air spring relative to the hinge point of the top member and/or by adjusting the length of the top member.

In actual reduction to practice, prototypes in accordance with aspects of the invention demonstrated low minimum lifting heights as well as ample maximum lifting heights and lifting capacities. One such prototype, designed in a manner similar to the illustrative pneumatic jack 100 and having a double convoluted air spring, for example, demonstrated a minimum lifting height of about three inches and a maximum lifting height of about 16 inches, thereby achieving a minimum lifting height similar to that of many floor jacks and a stroke of about 13 inches. Lifting capacity was estimated to be about 2,500 pounds or more. At the same time, the prototype was consistently safe, fast, and easy to use. Lift times (i.e., the time required to raise the prototype from its lowered condition to its raised condition) were estimated to be only a few seconds with about 105 psi input air. The handle and wheels made the prototype very easy to move and position.

Once the novel aspects of the invention are understood from the teachings herein, embodiments of the invention may, to a large extent, be formed utilizing conventional forming and fabrication techniques. Parts such as the base 102, the top member 104, the mounting block 132, the jack pad 142, the stabilizing member 146, the flanges 170, 172, 174, and the rods 118, 126, 150, 162, for example, are preferably (but not necessarily) formed from one or more metals such as steel, aluminum, or brass. These parts may be formed utilizing conventional metal fabrication techniques such as machining, stamping, forging, casting, cutting (manual and/or under computer numerical control (CNC)), bending, and welding. These metalworking techniques and others will be familiar to one having ordinary skill in the fabrication arts. Moreover, metalworking techniques are described in readily available references including, but not limited to, R. A. Walsh et al., McGraw-Hill 2006 Machining and Metalworking Handbook, McGraw-Hill, 2006, which is hereby incorporated by reference herein. After initial formation, the parts may also optionally be powder coated or plated with a surface coating (e.g., zinc or chrome) to increase durability.

Other elements required to form embodiments of the invention may be sourced from commercial vendors. Suitable rubber bladders may be sourced from, as just one example, Veyance® Technologies, Inc. (Fairlawn, Ohio, USA). Suitable gas control valves (e.g., lift and hoist type valves) and their associated components (e.g., pressure relief safety valves) may be sourced from, as just another example, Storm Manufacturing Group, Inc. (also known as Kingston Valves) (Torrance, Calif., USA).

It should again be emphasized that the above-described embodiments of the invention are intended to be illustrative only. Other embodiments can use different types and arrangements of elements for implementing the described functionality. As just one example, the coupling of one object to another (whether fixedly or pivotally) can be performed in ways different from those explicitly recited herein while still obtaining the same or similar overall functionality. Alternative embodiments may, as just a few examples, utilize attachment means such as screws, bolts, rods, adhesives, brackets, pins, hooks, welds, hinges, chemical bonds, and the like to implement aspects of the invention. These numerous alternative embodiments within the scope of the appended claims will be apparent to one skilled in the mechanical arts.

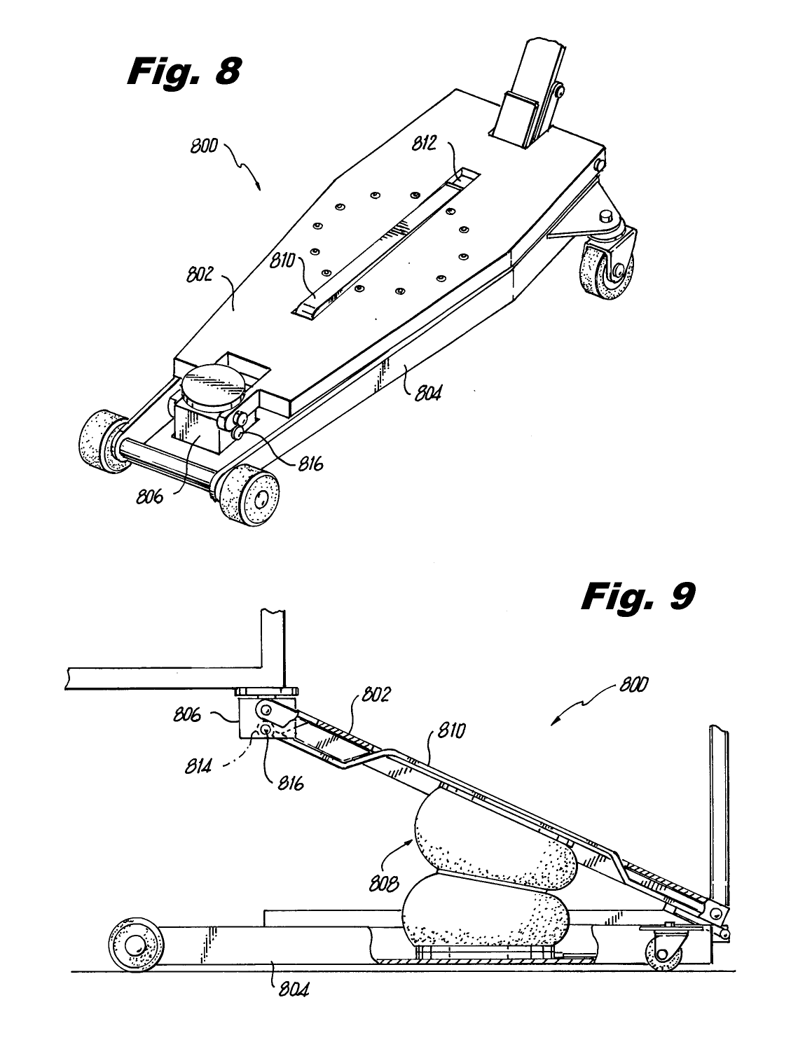

One or more alternative embodiments falling within the scope of the appended claims may also utilize very different forms of stabilizing members. FIGS. 8 and 9 show a pneumatic jack 800 in accordance with a second illustrative embodiment of the invention. FIG. 8 shows a left perspective view of the pneumatic jack 800, while FIG. 9 shows a partially cutaway left elevational view of the pneumatic jack 800.

While appearing somewhat different from the pneumatic jack 100, the pneumatic jack 800 contains many similar elements and therefore functions in an analogous manner. A top member 802 is pivotally mounted at its proximal end to a base 804. At the distal end of the top member 802, the top member 802 is pivotally mounted to a mounting block 806. An air spring 808 (double convoluted type) is disposed between the base 804 and the top member 802. Inflation of the air spring 808 causes the distal end of the top member 802 and the mounting block 806 to rise away from the base 804.

Nevertheless, while a stabilizing member 810 in the pneumatic jack 800 is also pivotally coupled to the base 804 and the mounting block 806 in a manner similar to the stabilizing member 146 in the pneumatic jack 100, the stabilizing member 810 itself has a substantially different shape. In the pneumatic jack 800, the stabilizing member 810 is shaped like a bar and passes over the top of the air spring 808 rather than around the air spring 808. This alternative path for the stabilizing member 810 is facilitated by a notch 812 in the top member 802. To pivotally couple to the mounting block 806, the stabilizing member 810 defines a single hollow cylinder 814 that surrounds a pin 816 that passes through the mounting block 806 and is exposed by a cutout in the bottom of the mounting block 806.

In use, the stabilizing member 810 cooperates with the top member 802 in the pneumatic jack 800 in a manner similar to the way the stabilizing member 146 and the top member 104 cooperate in the pneumatic jack 100. The stabilizing member 810 and the top member 802 act together to maintain the mounting block 806 at a substantially constant orientation relative to the base 804 while the pneumatic jack 800 raises the distal end of the top member 802 away from the base 804.

All the features disclosed herein may be replaced by alternative features serving the same, equivalent, or similar purposes, unless expressly stated otherwise. Thus, unless expressly stated otherwise, each feature disclosed is one example only of a generic series of equivalent or similar features.

Moreover, any element in a claim that does not explicitly state “means for” performing a specified function or “step for” performing a specified function is not to be interpreted as a “means for” or “step for” clause as specified in 35 U.S.C. §112, Paragraph 6. In particular, the use of “steps of” in the claims herein is not intended to invoke the provisions of 35 U.S.C. §112, Paragraph 6.

What is claimed is:

1. An apparatus comprising:
a base;
a top member, the top member defining a proximal end and a distal end, the proximal end pivotally coupled to the base; and
a bladder, the bladder disposed between the base and the top member;
wherein the apparatus is operative to raise the distal end of the top member away from the base as the bladder is inflated.

2. The apparatus of claim 1, wherein, after the bladder is inflated, the apparatus is operative to drop the distal end of the top member towards the base as the bladder is deflated.

3. The apparatus of claim 1, wherein the top member defines a hollow cylinder that at least partially surrounds a support rod in the base.

4. The apparatus of claim 1, further comprising a mounting block, the mounting block pivotally coupled to the distal end of the top member.

5. The apparatus of claim 4, wherein the mounting block is at least partially disposed between two extensions in the top member.

6. The apparatus of claim 4, wherein the mounting block is adapted to support a jack pad.

7. The apparatus of claim 4, further comprising a stabilizing member, the stabilizing member pivotally coupled to the base and to the mounting block.

8. The apparatus of claim 7, wherein the stabilizing member is pivotally coupled to the base and to the mounting block at different locations from the top member.

9. The apparatus of claim 7, wherein the apparatus is adapted to maintain the mounting block at a substantially constant orientation relative to the base while the apparatus raises the distal end of the top member away from the base.

10. The apparatus of claim 7, wherein the stabilizing member defines a hollow cylinder that at least partially surrounds a support rod in the base.

11. The apparatus of claim 7, wherein the stabilizing member defines an opening through which the bladder passes.

12. The apparatus of claim 7, wherein at least a portion of the stabilizing member passes over the bladder.

13. The apparatus of claim 7, wherein a length of the stabilizing member and a length of the top member along a longitudinal axis of the apparatus are substantially equal to one another.

14. The apparatus of claim 1, further comprising a valve, the valve operative to control inflation and deflation of the bladder.

15. The apparatus of claim 1, further comprising a handle, the handle coupled to the base at an angle that is manually adjustable.

16. The apparatus of claim 15, wherein the angle is manually adjustable at least in part by raising and lowering a pin into a receiving block defining a plurality of notches therein.

17. The apparatus of claim 1, further comprising a linking member, the linking member spanning between the base and the top member and operative to limit an extent to which the apparatus can raise the distal end of the top member away from the base.

18. The apparatus of claim 17, wherein the linking member is at least partially enclosed within the bladder.

19. The apparatus of claim 17, wherein the linking member comprises at least one of a chain, a cord, a cable, a strap, and a belt.

20. The apparatus of claim 1, wherein the bladder forms a portion of a single-convoluted air spring, a double convoluted air spring, or a triple convoluted air spring.

21. A method for lifting an object, the method comprising the steps of:
receiving a base;
pivotally coupling a proximal end of a top member to the base;
placing a bladder between the base and the top member; and
raising a distal end of the top member away from the base by inflating the bladder.
